(19) United States
(12) Patent Application Publication
(10) Pub. No.: US 2022/0344631 A1
(43) Pub. Date: Oct. 27, 2022

(54) METHOD FOR MANUFACTURING POSITIVE ELECTRODE MATERIAL FOR ELECTRICITY STORAGE DEVICE

(71) Applicant: NIPPON ELECTRIC GLASS CO., LTD., Otsu-shi, Shiga (JP)

(72) Inventors: Ayumu TANAKA, Otsu-shi (JP); Hideo YAMAUCHI, Otsu-shi (JP); Junichi IKEJIRI, Otsu-shi (JP); Kei TSUNODA, Otsu-shi (JP)

(21) Appl. No.: 17/636,630

(22) PCT Filed: Sep. 14, 2020
(86) PCT No.: PCT/JP2020/034636

§ 371 Date: Feb. 18, 2022

(30) Foreign Application Priority Data
Sep. 20, 2019 (JP) 2019-171541
Dec. 24, 2019 (JP) 2019-232729

(51) Int. Cl. H01M 4/04; H01M 10/0562; H01M 4/62; H01M 4/48

(52) U.S. Cl. CPC H01M 4/0471; H01M 10/0562; H01M 4/625; H01M 4/48; H01M 2004/021

(57) ABSTRACT

The present invention provides a method for manufacturing a positive electrode material for an electricity storage device that can reduce excessive reactions between particles of a positive electrode active material precursor powder and between the positive electrode active material precursor powder and a solid electrolyte during thermal treatment to achieve excellent charge and discharge characteristics. A method for manufacturing a positive electrode material for an electricity storage device includes the step of subjecting a raw material containing a positive electrode active material precursor powder made of an amorphous oxide material to thermal treatment, wherein the positive electrode active material precursor powder has a crystallization temperature of 490° C. or lower.

### TECHNICAL FIELD

The present invention relates to methods for manufacturing positive electrode materials for use in electricity storage devices, such as sodium-ion secondary cells.

### BACKGROUND ART

Lithium-ion secondary cells have secured their place as high-capacity and light-weight power sources essential for mobile electronic terminals, electric vehicles, and so on and attention has been focused, as their positive electrode active materials, on active materials containing olivine crystals represented by the general formula LiFePO₄. However, because, as for lithium, there are concerns about such issues as global rise in raw material costs, studies have recently been conducted on sodium-ion secondary cells as alternatives to lithium-ion secondary cells. Patent Literature 1 discloses positive electrode active materials made of NaₓM_{y}P₂O₇ crystals (where M represents at least one transition metal element selected from Fe, Cr, Mn, Co and Ni, 1.20≤x≤2.10, and 0.95≤y≤1.60). Patent Literature 2 discloses a method for producing an all-solid-state cell using a similar sodium-containing positive electrode active material.

### CITATION LIST

### Patent Literature

[PTL 1]
WO2013/133369
[PTL 2]
WO2016/084573

### SUMMARY OF INVENTION

### Technical Problem

In the positive electrode active material for a sodium-ion secondary cell described in Patent Literature 1, in order to cause the positive electrode active material to develop cell characteristics, it is necessary to fire a glass powder as a precursor of the positive electrode active material at a high temperature to reduce Fe ions in the glass powder from trivalent ions to divalent ions. However, this technique has a problem that because the glass powder particles excessively fuse together during firing and, thus, coarse particles are formed, the specific surface area of the positive electrode active material becomes small, so that desired cell characteristics cannot be obtained.

In producing an all-solid-state cell, a positive electrode active material precursor powder is integrally fired with a solid electrolyte powder made of beta-alumina, NASICON crystals or so on. By doing so, the adhesiveness between the positive electrode active material powder and the solid electrolyte powder after firing increases, so that a solid secondary cell having an excellent discharge characteristic can be produced. However, as described in Patent Literature 2, there is a problem that the positive electrode active material precursor powder and the solid electrolyte powder react with each other during firing and, thus, maricite NaFePO₄ crystals not contributing to charge and discharge precipitate, so that the charge and discharge capacities decrease.

In addition, elements contained in the positive electrode active material precursor powder and elements contained in the solid electrolyte mutually diffuse during firing, so that a high-resistance layer is partially formed and, thus, the rate characteristics of the all-solid-state cell may decrease. In order to reduce the formation of a high-resistance layer, there is proposed a technique of coating each of the materials with a barrier layer using an alkoxide material or the like. However, this technique has a problem that because the alkoxide material is expensive, the cost rises.

In view of the foregoing, the present invention has an object of providing a method for manufacturing a positive electrode material for an electricity storage device that can reduce excessive reactions between particles of a positive electrode active material precursor powder and between the positive electrode active material precursor powder and a solid electrolyte during thermal treatment to achieve excellent charge and discharge characteristics.

### Solution to Problem

A method for manufacturing a positive electrode material for an electricity storage device according to the present invention includes the step of subjecting a raw material containing a positive electrode active material precursor powder made of an amorphous oxide material to a thermal treatment, wherein the positive electrode active material precursor powder has a crystallization temperature of 490° C. or lower. With the use of, as a raw material, the positive electrode active material precursor powder having a crystallization temperature as low as 490° C. or lower, the positive electrode active material precursor powder can be promoted in crystallization even when thermally treated (fired) at a low temperature. Thus, the temperature during the thermal treatment can be set at a low temperature, so that an excessive reaction between raw material components during the thermal treatment can be reduced. As a result, a positive electrode material having excellent charge and discharge characteristics (particularly, charge and discharge characteristics at a relatively high rate of 0.1 C or more) can be manufactured. In the present invention, the crystallization temperature refers to a value measured by DTA (differential thermal analysis).

In the method for manufacturing a positive electrode material for an electricity storage device according to the present invention, a temperature during the thermal treatment is preferably 400 to 600° C. Thus, an excessive reaction between raw material components can be reduced, so that a positive electrode material having excellent charge and discharge characteristics can be manufactured.

In the method for manufacturing a positive electrode material for an electricity storage device according to the present invention, a time for the thermal treatment is preferably less than three hours. Thus, an excessive reaction between raw material components can be reduced, so that a positive electrode material having excellent charge and discharge characteristics can be manufactured.

In the method for manufacturing a positive electrode material for an electricity storage device according to the present invention, the thermal treatment is preferably performed in a reductive atmosphere. By doing so, the valence of a transition metal element in the positive electrode active material precursor powder can be controlled to be a lower value. Thus, the occurrence of a crystalline phase not acting as an active material during the thermal treatment can be reduced, so that a positive electrode material having excellent charge and discharge capacities can be manufactured.

In the method for manufacturing a positive electrode material for an electricity storage device according to the present invention, the positive electrode active material precursor powder preferably has an average particle diameter of 0.01 to less than 0.7 μm. Thus, the crystallization temperature of the positive electrode active material precursor powder can be decreased. In addition, the specific surface area of the positive electrode active material precursor powder becomes large and, thus, the contact area thereof with an atmosphere gas increase, so that the valence of a transition metal element in the positive electrode active material precursor powder can be easily controlled.

In the method for manufacturing a positive electrode material for an electricity storage device according to the present invention, the positive electrode active material precursor powder preferably contains, in terms of % by mole of the following oxides, 25 to 55% Na₂O, 10 to 30% Fe₂O₃+Cr₂O₃+MnO+CoO+NiO, and 25 to 55% P₂O₅. Note that, herein, “x+y+ . . . ” means the total content of these components.

In the method for manufacturing a positive electrode material for an electricity storage device according to the present invention, the raw material preferably contains a solid electrolyte powder.

In the method for manufacturing a positive electrode material for an electricity storage device according to the present invention, the solid electrolyte powder is preferably β-alumina, β″-alumina or NASICON crystals.

In the method for manufacturing a positive electrode material for an electricity storage device according to the present invention, the solid electrolyte powder preferably has an average particle diameter of 0.05 to 3 μm. Thus, an ion-conducting path is more likely to be formed in the positive electrode material, so that the charge and discharge characteristics are more likely to increase.

In the method for manufacturing a positive electrode material for an electricity storage device according to the present invention, the raw material preferably contains a conductive carbon. Thus, a conducting path is more likely to be formed in the positive electrode material, so that the charge and discharge characteristics are more likely to increase.

In the method for manufacturing a positive electrode material for an electricity storage device according to the present invention, the raw material preferably contains, in terms of % by mass, 30 to 100% positive electrode active material precursor powder, 0 to 70% solid electrolyte powder, and 0 to 20% conductive carbon.

A positive electrode active material precursor powder for an electricity storage device according to the present invention is made of an amorphous oxide material having a crystallization temperature of 490° C. or lower.

The positive electrode active material precursor powder for an electricity storage device according to the present invention preferably has an average particle diameter of 0.01 to less than 0.7 μm.

The positive electrode active material precursor powder for an electricity storage device according to the present invention preferably contains, in terms of % by mole of the following oxides, 25 to 55% Na₂O, 10 to 30% Fe₂O₃+Cr₂O₃+MnO+CoO+NiO, and 25 to 55% P₂O₅.

A positive electrode material for an electricity storage device according to the present invention contains a solid electrolyte and a positive electrode active material and has a matrix-domain structure formed of the positive electrode active material as a matrix component and the solid electrolyte as a domain component.

In the positive electrode material for an electricity storage device according to the present invention, a number of solid electrolyte powder particles having a particle diameter of 0.5 μm or less is preferably two or more in a 1 μm×1 μm cross-sectional view area.

An electricity storage device according to the present invention includes a positive electrode material layer made of the above-described positive electrode material for an electricity storage device.

The electricity storage device according to the present invention preferably includes a solid electrolyte layer, wherein the positive electrode material layer is formed on a surface of the solid electrolyte layer.

In the electricity storage device according to the present invention, a heterogeneous phase at an interface between the positive electrode material layer and the solid electrolyte layer preferably has a thickness of 1 μm or less.

In the electricity storage device according to the present invention, an internal resistance per unit area of the positive electrode material layer at 30° C. is preferably 2000 Ωcm² or less as a minimum value in a discharge process.

### Advantageous Effects of Invention

The present invention reduces excessive reactions between particles of a positive electrode active material precursor powder and between the positive electrode active material precursor powder and a solid electrolyte during thermal treatment to enable production of a positive electrode material for an electricity storage device having excellent charge and discharge characteristics.

### BRIEF DESCRIPTION OF DRAWINGS

FIG. 1(a) shows an elemental mapping profile of a positive electrode material layer in Example 1, and FIG. 1(b) shows an elemental mapping profile of a positive electrode material layer in a comparative example.

### DESCRIPTION OF EMBODIMENTS

A method for manufacturing a positive electrode material for an electricity storage device according to the present invention includes the step of subjecting a raw material containing a positive electrode active material precursor powder made of an amorphous oxide material to a thermal treatment. Hereinafter, a detailed description will be given of material components on a component-by-component basis.

(1) Positive Electrode Active Material Precursor Powder

The positive electrode active material precursor powder is made of an amorphous oxide material that generates positive electrode active material crystals when subjected to a thermal treatment. When subjected to the thermal treatment, the amorphous oxide material not only generates the positive electrode active material crystals, but also can be softened and fluidized to forma dense positive electrode material layer. As a result, an ion-conducting path is formed well, which is favorable. In the present invention, the term “amorphous oxide material” is not limited to a fully amorphous oxide material, and includes those partially containing crystals (for example, those having a crystallinity of 10% or less).

The crystallization temperature of the positive electrode active material precursor powder is 490° C. or lower, preferably 470° C. or lower, and particularly preferably 450° C. or lower. If the crystallization temperature of the positive electrode active material precursor powder is too high, it is necessary to thermally treat the raw material at a high temperature in order to crystallize the positive electrode active material precursor powder. In addition, the time for the thermal treatment (the holding time at a maximum temperature) may be long. As a result, the positive electrode active material precursor powder particles excessively fuse together during the thermal treatment and, thus, coarse particles are formed, so that the specific surface area of the positive electrode active material tends to be small and the charge and discharge characteristics tend to decrease. In addition, in the case of an all-solid-state cell, the positive electrode active material precursor powder and the solid electrolyte powder react with each other during the thermal treatment and, thus, crystals not contributing to charge and discharge (such as maricite NaFePO₄ crystals) precipitate, so that the charge and discharge capacities may decrease. Alternatively, elements contained in the positive electrode active material precursor powder and elements contained in the solid electrolyte mutually diffuse during the thermal treatment, so that a high-resistance layer is partially formed and, thus, the rate characteristics of the all-solid-state cell may decrease. The lower limit of the crystallization temperature of the positive electrode active material precursor powder is not particularly limited, but it is, actually, preferably not lower than 300° C. and more preferably not lower than 350° C.

The crystallization temperature of the positive electrode active material precursor powder varies depending not only on the composition, but also on the particle diameter. Specifically, when the particle diameter of the positive electrode active material precursor powder is smaller, the specific surface area thereof becomes larger, so that the surface energy increases and, thus, surface crystallization is likely to occur. As a result, the crystallization temperature is likely to decrease.

The positive electrode active material precursor powder preferably contains, in terms of % by mole of the following oxides, 25 to 55% Na₂O, 10 to 30% Fe₂O₃+Cr₂O₃+MnO+CoO+NiO, and 25 to 55% P₂O₅. The reasons why the composition is limited as just described will be described below. In the following description of the respective contents of the components, “%” refers to “% by mole” unless otherwise stated.

Na₂O is a main component of the positive electrode active material crystals represented by the general formula NaₓMa_{y}P₂O_{z} (where M represents at least one transition metal element selected from Fe, Cr, Mn, Co and Ni, 1.20≤x≤2.10, and 0.95≤y≤1.60). The content of Na₂O is preferably 25 to 55% and particularly preferably 30 to 50%. If the content of Na₂O is too small or too large, the charge and discharge capacities tend to decrease.

Fe₂O₃, Cr₂O₃, MnO, CoO, and NiO are also main components of the positive electrode active material crystals represented by the general formula NaₓMa_{y}P₂O_{z}. The content of Fe₂O₃+Cr₂O₃+MnO+CoO+NiO is preferably 10 to 30% and particularly preferably 15 to 25%. If the content of Fe₂O₃+Cr₂O₃+MnO+CoO+NiO is too small, the charge and discharge capacities tend to decrease. On the other hand, if the content of Fe₂O₃+Cr₂O₃+MnO+CoO+NiO is too large, undesirable crystals, such as Fe₂O₃, Cr₂O₃, MnO, CoO or NiO, are likely to precipitate. In order to increase the cycle characteristics, Fe₂O₃ is preferably positively contained in the positive electrode active material precursor powder. The content of Fe₂O₃ is preferably 1 to 30%, more preferably 5 to 30%, still more preferably 10 to 30%, and particularly preferably 15 to 25%. The content of each component of Cr₂O₃, MnO, CoO, and NiO is preferably 0 to 30%, more preferably 10 to 30%, and particularly preferably 15 to 25%. In containing at least two components selected from Fe₂O₃, Cr₂O₃, MnO, CoO, and NiO in the positive electrode active material precursor powder, the total content of them is preferably 10 to 30% and particularly preferably 15 to 25%.

P₂O₅ is also a main component of the positive electrode active material crystals represented by the general formula NaₓMa_{y}P₂O_{z}. The content of P₂O₅ is preferably 25 to 55% and particularly preferably 30 to 50%. If the content of P₂O₅ is too small or too large, the charge and discharge capacities tend to decrease.

The positive electrode active material precursor powder may contain, in addition to the above components, V₂O₅, Nb₂O₅, MgO, Al₂O₃, TiO₂, ZrO₂ or Sc₂O₃. These components have the effect of increasing the conductivity (electronic conductivity), which makes it likely that the rapid charge and discharge characteristics of the positive electrode active material increase. The total content of these components is preferably 0 to 25% and particularly preferably 0.2 to 10%. If the content of these components is too large, heterogeneous crystals not contributing to the cell characteristics are generated, so that the charge and discharge capacities are likely to decrease.

Aside from the above components, the positive electrode active material precursor powder may contain SiO₂, B₂O₃, GeO₂, Ga₂O₃, Sb₂O₃ or Bi₂O₃. When the positive electrode active material precursor powder contains these components, the glass formation ability increases, so that a homogeneous positive electrode active material precursor powder is likely to be obtained. The total content of these components is preferably 0 to 25% and particularly preferably 0.2 to 10%. Because these components do not contribute to the cell characteristics, an excessively large content of them leads to a tendency to decrease the charge and discharge capacities.

The positive electrode active material precursor powder is preferably made by melting a raw material batch and forming the melt into a shape. This method is preferred because an amorphous positive electrode active material precursor powder having excellent homogeneity can be easily obtained. Specifically, the positive electrode active material precursor powder can be produced in the following manner.

First, raw materials are formulated to give a desired composition, thus obtaining a raw material batch. Next, the obtained raw material batch is melted. It is sufficient for the melting temperature to be appropriately adjusted so that the raw material batch can be homogeneously melted. For example, the melting temperature is preferably 800° C. or higher and particularly preferably 900° C. or higher. The upper limit of the melting temperature is not particularly limited, but an excessively high melting temperature leads to energy loss or evaporation of the sodium component and so on. Therefore, the melting temperature is preferably not higher than 1500° C. and particularly preferably not higher than 1400° C.

Next, the obtained melt is formed into a shape. The method for forming the melt into a shape is not particularly limited. For example, the melt may be formed into a film with rapid cooling by pouring the melt between a pair of cooling rolls or formed into an ingot by casting the melt into a mold.

Subsequently, the obtained formed body is ground to obtain a positive electrode active material precursor powder. The average particle diameter of the positive electrode active material precursor powder is preferably 0.01 to less than 0.7 μm, more preferably 0.03 to less than 0.7 μm, still more preferably 0.05 to 0.6 μm, and particularly preferably 0.1 to 0.5 μm. If the average particle diameter of the positive electrode active material precursor powder is too small, the cohesion between the powder particles increases when the positive electrode active material precursor powder is used in paste form, so that it is less likely to be dispersed into the paste. In addition, in mixing the positive electrode active material precursor powder with a solid electrolyte powder or the like, it is difficult to uniformly disperse the positive electrode active material precursor powder into the mixture, so that the internal resistance increases and, thus, the charge and discharge capacities may decrease. On the other hand, if the average particle diameter of the positive electrode active material precursor powder is too large, the crystallization temperature tends to be high. In addition, the amount of ions diffusing per unit surface area of the positive electrode material decreases, so that the internal resistance tends to increase. Furthermore, in mixing the positive electrode active material precursor powder with a solid electrolyte powder, the adhesiveness between the positive electrode active material precursor powder and the solid electrolyte powder decreases, so that the mechanical strength of the positive electrode material layer decreases and, as a result, the charge and discharge capacities tend to decrease. Alternatively, the adhesiveness between the positive electrode material layer and the solid electrolyte layer becomes poor, so that the positive electrode material layer may peel off from the solid electrolyte layer.

In the present invention, the average particle diameter means D₅₀ (a volume-based average particle diameter) and refers to a value measured by the laser diffraction/scattering method.

(2) Other Raw Material Components

(Solid Electrolyte Powder)

A solid electrolyte powder is a component that plays a role in conducting ions through the positive electrode material layer in an all-solid-state electricity storage device.

Examples of the solid electrolyte powder include beta-alumina and NASICON crystals both of which have excellent sodium ion-conductivity. Beta-alumina includes two types of crystals: β-alumina (theoretical composition formula: Na₂O.11Al₂O₃) and β″-alumina (theoretical composition formula: Na₂O.5.3Al₂O₃). β″-alumina is a metastable material and is therefore generally used in a state in which Li₂O or MgO is added as a stabilizing agent thereto. β″-alumina has a higher sodium-ion conductivity than β-alumina. Therefore, β″-alumina alone or a mixture of β″-alumina and β-alumina is preferably used and Li₂O-stabilized β″-alumina (Na_{1.7}Li_{0.3}Al_{10.7}O₁₇) or MgO-stabilized β″-alumina ((Al_{10.32}Mg_{0.68}O₁₆) (Na_{1.68}O)) is more preferably used.

Examples of the NASICON crystal include Na₃Zr₂Si₂PO₁₂, Na_{3.2}Zr_{1.3}Si_{2.2}P_{0.7}O_{10.5}, Na₃Zr_{1.6}Ti_{0.4}Si₂PO₁₂, Na₃Hf₂Si₂PO₁₂, Na_{3.4}Zr_{0.9}Hf_{1.4}Al_{0.6}Si_{1.2}P_{1.8}O₁₂, Na₃Zr_{1.7}Nb_{0.24}Si₂PO₁₂, Na_{3.6}Ti_{0.2}Y_{0.7}Si_{2.8}O₉, Na₃Zr_{1.88}Y_{0.12}Si₂PO₁₂, Na_{3.12}Zr_{1.88}Y_{0.12}Si₂PO₁₂, and Na_{3.6}Zr_{0.13}Yb_{1.67}Si_{0.11}P_{2.9}O₁₂, and Na_{3.12}Zr_{1.88}Y_{0.12}Si₂PO₁₂ is particularly preferred because it has excellent sodium-ion conductivity.

The average particle diameter of the solid electrolyte powder is preferably 0.05 to 3 μm, more preferably 0.05 to less than 1.8 μm, still more preferably 0.05 to 1.5 μm, yet still more preferably 0.1 to 1.2 μm, and particularly preferably 0.1 to 0.9 μm. If the average particle diameter of the solid electrolyte powder is too small, not only the solid electrolyte powder becomes difficult to uniformly mix together with the positive electrode active material precursor powder, but also may absorb moisture or become carbonated to decrease the ionic conductivity or may promote an excessive reaction with the positive electrode active material precursor powder. As a result, the internal resistance of the positive electrode material layer increases, so that the voltage characteristics and the charge and discharge capacities tend to decrease. On the other hand, if the average particle diameter of the solid electrolyte powder is too large, this significantly inhibits the softening and flow of the positive electrode active material precursor powder, so that the resultant positive electrode material layer tends to have poor smoothness to decrease the mechanical strength and tends to increase the internal resistance.

(Conductive Carbon)

A conductive carbon is a component that forms a conducting path in the positive electrode material. In adding the conductive carbon, it is preferably added when the positive electrode active material precursor powder is ground. The conductive carbon not only plays a role as a grinding aid to enable homogeneous mixture with the positive electrode active material precursor powder, but also reduces excessive fusion of the positive electrode active material precursor powder particles during the thermal treatment, so that the electrical conductivity is likely to be ensured and the rapid charge and discharge characteristics are likely to increase.

(Binder)

A binder is a material for binding the raw material components (raw material component powders) together. Examples of the binder include: cellulose derivatives, such as carboxymethyl cellulose, hydroxypropyl methylcellulose, hydroxypropyl cellulose, ethyl cellulose, hydroxyethyl cellulose, and hydroxymethyl cellulose, or water-soluble polymers, such as polyvinyl alcohol; thermosetting resins, such as thermosetting polyimide, phenolic resin, epoxy resin, urea resin, melamine resin, unsaturated polyester resin, and polyurethane; polycarbonate-based resins, such as polypropylene carbonate; and polyvinylidene fluoride.

(3) Composition of Raw Material

The raw material preferably contains, in terms of % by mass, 30 to 100% positive electrode active material precursor powder, 0 to 70% solid electrolyte powder, and 0 to 20% conductive carbon, more preferably contains 44.5 to 94.5% positive electrode active material precursor powder, 5 to 55% solid electrolyte powder, and 0.5 to 15% conductive carbon, and still more preferably contains 50 to 92% positive electrode active material precursor powder, 7 to 50% solid electrolyte powder, and 1 to 10% conductive carbon. If the content of the positive electrode active material precursor powder is too small, the amount of components that absorb or release sodium ions with charge and discharge in the positive electrode material becomes small, so that the charge and discharge capacities of the electricity storage device tend to decrease. If the content of the conductive carbon or the solid electrolyte powder is too large, the bindability of the positive electrode material precursor powder decreases to increase the internal resistance and, therefore, the voltage characteristics and the charge and discharge capacities tend to decrease.

The mixing of the raw material components can be made using a mixer, such as a planetary centrifugal mixer or a tumbler mixer, or a general grinder, such as a mortar, a mortar mixer, a ball mill, an attritor, a vibrating ball mill, a satellite ball mill, a planetary ball mill, a jet mill or a bead mill. Particularly, a planetary ball mill is preferably used. Because the planetary ball mill has a structure in which a disk rotates while pots thereon rotate, so that very high impact energy can be efficiently produced, the raw material components can be homogeneously dispersed.

(4) Thermal Treatment Conditions

The temperature during the thermal treatment (the maximum temperature during the thermal treatment) is preferably 400 to 600° C., more preferably 410 to 580° C., still more preferably 420 to 575° C., and particularly preferably 425 to 560° C. In terms of the relationship with the crystallization temperature of the positive electrode active material precursor powder, the temperature during the thermal treatment is, with respect to the crystallization temperature of the positive electrode active material precursor powder, preferably +0° C. to +200° C., more preferably +30° C. to +150° C., and particularly preferably +50° C. to +120° C. If the temperature during the thermal treatment is too low, the crystallization of the positive electrode active material precursor powder becomes insufficient, so that a remaining amorphous phase serves as a high-resistance portion and, thus, the voltage characteristics and the charge and discharge capacities tend to decrease. On the other hand, if the temperature during the thermal treatment is too high, the positive electrode active material precursor powder particles excessively fuse together and, thus, coarse particles are formed, so that the specific surface area of the positive electrode active material tends to be small and the charge and discharge characteristics tend to decrease. In addition, in the case of an all-solid-state cell, the positive electrode active material precursor powder and the solid electrolyte powder react with each other during the thermal treatment and, thus, crystals not contributing to charge and discharge (such as maricite NaFePO₄ crystals) precipitate, so that the charge and discharge capacities may decrease. Alternatively, elements contained in the positive electrode active material precursor powder and elements contained in the solid electrolyte mutually diffuse during the thermal treatment, so that a high-resistance layer is partially formed and, thus, the rate characteristics of the all-solid-state cell may decrease.

The time for the thermal treatment (the holding time at the maximum temperature during the thermal treatment) is preferably less than three hours, more preferably two hours or less, still more preferably an hour or less, and particularly preferably 45 minutes or less. If the time for the thermal treatment is too long, the positive electrode active material precursor powder particles excessively fuse together and, thus, coarse particles are likely to be formed, so that the specific surface area of the positive electrode active material tends to be small and the charge and discharge characteristics tend to decrease. In addition, in the case of an all-solid-state cell, the positive electrode active material precursor powder and the solid electrolyte powder react with each other during the thermal treatment and, thus, crystals not contributing to charge and discharge (such as maricite NaFePO₄ crystals) precipitate, so that the charge and discharge capacities may decrease. Alternatively, elements contained in the positive electrode active material precursor powder and elements contained in the solid electrolyte mutually diffuse during the thermal treatment, so that a high-resistance layer is partially formed and, thus, the rate characteristics of the all-solid-state cell may decrease. On the other hand, if the time for the thermal treatment is too short, the crystallization of the positive electrode active material precursor powder becomes insufficient, so that a remaining amorphous phase serves as a high-resistance portion and, thus, the voltage characteristics and the charge and discharge capacities tend to decrease. Therefore, the time for the thermal treatment is preferably not less than one minute and particularly preferably not less than five minutes.

The atmosphere during the thermal treatment is preferably a reductive atmosphere. Examples of the reductive atmosphere include atmospheres containing at least one reducing gas selected from H₂, NH₃, CO, H₂S, and SiH₄. From the viewpoint of efficiently reducing Fe ions in the positive electrode active material precursor powder from trivalent to divalent ions, the atmosphere preferably contains at least one selected from H₂, NH₃ and CO and particularly preferably contains H₂ gas. In using H₂ gas, an inert gas, such as N₂, is preferably mixed with H₂ gas for the purpose of reducing the risks of explosion and the like during the thermal treatment. Specifically, the reducing gas preferably contains, in terms of % by volume, 90 to 99.9% N₂ and 0.1 to 10% H₂, more preferably contains 90 to 99.5% N₂ and 0.5 to 10% H₂, and still more preferably contains 92 to 99% N₂ and 1 to 8% H₂.

For the thermal treatment, a general thermal treatment apparatus, such as an electric heating furnace, a rotary kiln, a microwave heating furnace or a high-frequency heating furnace, can be used.

(5) Characteristics of Positive Electrode Material Layer

The positive electrode material layer obtained in the above manner preferably has the following characteristics.

The positive electrode material for an electricity storage device according to the present invention preferably contains a solid electrolyte and a positive electrode active material and has a matrix-domain structure formed of the positive electrode active material as a matrix component and the solid electrolyte as a domain component. In this relation, when a cross section of the positive electrode material layer is observed with FESEM-EDX (a field emission-type scanning electron microscope with an energy dispersive X-ray spectrometer), the number of solid electrolyte powder particles having a particle diameter of 0.5 μm or less in a 1 μm×1 μm view area is preferably 2/μm² or more and particularly preferably 4/μm² or more. Thus, an ion-conducting path is more likely to be formed in the positive electrode material layer, so that the discharge capacity can be increased. If the number of solid electrolyte powder particles having a particle diameter of 0.5 μm or less in a 1 μm×1 μm view area is too large, the rate of the positive electrode active material in the positive electrode material layer becomes relatively small, so that the discharge capacity may decrease. Therefore, the upper limit thereof is preferably not more than 30/μm² and particularly preferably not more than 20/μm².

Alternatively, when the cross section of the positive electrode material layer is observed with FESEM-EDX, the area rate of solid electrolyte powder particles having a particle diameter of 0.5 μm or less in a 1 μm×1 μm view area is preferably 10% or more and particularly preferably 15% or more. Thus, an ion-conducting path is more likely to be formed in the positive electrode material layer, so that the discharge capacity can be increased. If the area rate of solid electrolyte powder particles having a particle diameter of 0.5 μm or less in a 1 μm×1 μm view area is too large, the rate of the positive electrode active material in the positive electrode material layer becomes relatively small, so that the discharge capacity may decrease. Therefore, the upper limit thereof is preferably not more than 60% and particularly preferably not more than 50%.

The above number and area rate of solid electrolyte powder particles can be determined based on a mapping of elements contained in the solid electrolyte powder.

An electricity storage device including a positive electrode material layer made of the positive electrode material according to the present invention preferably has the following characteristics. The electricity storage device preferably includes, for example, a solid electrolyte layer, wherein the positive electrode material layer is formed on a surface of the solid electrolyte layer. Furthermore, it is preferred that a negative electrode material layer is formed on the surface of the solid electrolyte layer opposite to the surface thereof on which the positive electrode material layer is formed.

If a heterogeneous phase made of crystals not contributing to charge and discharge (such as maricite NaFePO₄ crystals) is formed at the interface between the positive electrode material layer and the solid electrolyte layer, an ion-conducting path is less likely to be formed, so that the discharge capacity tends to decrease. Therefore, the thickness of the heterogeneous phase is preferably less than 1 μm, more preferably 0.8 μm or less, and particularly preferably 0.6 μm or less, and no formation of the heterogeneous phase is most preferred.

The internal resistance per unit area of the positive electrode material layer at 30° C. is, as a minimum value in a discharge process, preferably 2000 Ωcm² or less, more preferably 1000 Ωcm² or less, still more preferably 600 Ωcm² or less, yet still more preferably 300 Ωcm² or less, and particularly preferably 100 Ωcm² or less. Thus, the output characteristics increase, so that the discharge capacity can be increased.

### EXAMPLES

Hereinafter, a detailed description will be given of examples where the present invention was applied to an all-solid-state sodium-ion secondary cell. The present invention is not at all limited to the following examples.

Table 1 shows Examples 1 to 9 and a comparative example.

TABLE 1

| | | | | Example | | | | | |
|---|---|---|---|---|---|---|---|---|---|
| | | | | 1 | 2 | 3 | 4 | 5 | 6 |
| Positive | Positive | Crystallization | | 437 | 437 | 437 | 437 | 426 | 418 |
| electrode | electrode | temperature (° C.) | | | | | | | |
| material | active | Average particle | | 0.3 | 0.3 | 0.3 | 0.3 | 0.2 | 0.1 |
| | material | diameter (μm) | | | | | | | |
| | precursor | Content | | 72 | 83 | 83 | 83 | 83 | 83 |
| | powder | (% by mass) | | | | | | | |
| | Solid | Type | | β″-alumina | β″-alumina | β″-alumina | β″-alumina | β″-alumina | NASICON |
| | electrolyte | Average particle | | 2 | 0.4 | 0.4 | 0.4 | 0.1 | 0.1 |
| | powder | diameter (μm) | | | | | | | |
| | | Content | | 25 | 13 | 13 | 13 | 13 | 13 |
| | | (% by mass) | | | | | | | |
| | Conductive | Content | | 3 | 4 | 4 | 4 | 4 | 4 |
| | carbon | (% by mass) | | | | | | | |
| Thermal | Atmosphere | | | N₂/H₂ (96/4 % by volume) | | | | | |
| treatment | Temperature/Time | | | 525° C./ | 525° C./ | 550° C./ | 525° C./ | 525° C./ | 525° C./ |
| conditions | | | | 30 min. | 30 min. | 30 min. | 1 hr. | 30 min. | 30 min. |
| Number of solid electrolyte powder particles | | | | 0 | 5 | 4 | 5 | 8 | 10 |
| with a diameter of 0.5 μm or less per unit | | | | | | | | | |
| area (number/μm²) | | | | | | | | | |
| Area rate of solid electrolyte powder | | | | 0 | 24 | 17 | 21 | 18 | 34 |
| particles with a diameter of 0.5 μm or less | | | | | | | | | |
| per unit area (%) | | | | | | | | | |
| Thickness of heterogeneous phase (μm) | | | | <0.5 | <0.5 | <0.5 | <0.5 | <0.5 | <0.5 |
| Internal resistance (Ω/cm²) | | | | 457 | 283 | 361 | 472 | 264 | 319 |
| Cell | Discharge | 0.02 | C | 84 | 94 | 86 | 90 | 93 | 91 |
| characteristics | capacity | 0.1 | C | 67 | 85 | 77 | 75 | 82 | 78 |
| | (mAh/g) | 0.2 | C | 56 | 77 | 71 | 66 | 76 | 72 |
| | | 1 | C | 39 | 66 | 56 | 0 | 70 | 67 |

| | | | | Example | | | |
|---|---|---|---|---|---|---|---|
| | | | | 7 | 8 | 9 | Comp. Ex. |
| Positive | Positive | Crystallization | | 442 | 418 | 411 | 580 |
| electrode | electrode | temperature (° C.) | | | | | |
| material | active | Average particle | | 0.4 | 0.1 | 0.05 | 0.8 |
| | material | diameter (μm) | | | | | |
| | precursor | Content | | 86 | 83 | 83 | 72 |
| | powder | (% by mass) | | | | | |
| | Solid | Type | | β″-alumina | β″-alumina | β″-alumina | β″-alumina |
| | electrolyte | Average particle | | 0.3 | 0.4 | 0.4 | 2 |
| | powder | diameter (μm) | | | | | |
| | | Content | | 11 | 13 | 13 | 25 |
| | | (% by mass) | | | | | |
| | Conductive | Content | | 3 | 4 | 4 | 3 |
| | carbon | (% by mass) | | | | | |
| Thermal | Atmosphere | | | N₂/H₂ (96/4 % by volume) | | | |
| treatment | Temperature/Time | | | 525° C./ | 512° C./ | 512° C./ | 620° C./ |
| conditions | | | | 30 min. | 30 min. | 30 min. | 1 hr. |
| Number of solid electrolyte powder particles | | | | 6 | 5 | 4 | 0 |
| with a diameter of 0.5 μm or less per unit | | | | | | | |
| area (number/μm²) | | | | | | | |
| Area rate of solid electrolyte powder | | | | 23 | 22 | 19 | 0 |
| particles with a diameter of 0.5 μm or less | | | | | | | |
| per unit area (%) | | | | | | | |
| Thickness of heterogeneous phase (μm) | | | | <0.5 | <0.5 | <0.5 | 1 |
| Internal resistance (Ω/cm²) | | | | 528 | 245 | 233 | 2612 |
| Cell | Discharge | 0.02 | C | 79 | 92 | 96 | 68 |
| characteristics | capacity | 0.1 | C | 58 | 87 | 92 | 35 |
| | (mAh/g) | 0.2 | C | 42 | 82 | 87 | 0 |
| | | 1 | C | 0 | 71 | 75 | 0 |

(a) Making of Positive Electrode Active Material Precursor Powder

Using sodium metaphosphate (NaPO₃), iron oxide (Fe₂O₃), and orthophosphoric acid (H₃PO₄) as raw materials, these powdered raw materials were formulated to give a composition of, in terms of % by mole, 40% Na₂O, 20% Fe₂O₃, and 40% P₂O₅ and melted at 1250° C. for 45 minutes in an air atmosphere. Thereafter, the melt was poured between a pair of rotating rollers and formed into a shape with rapid cooling, thus obtaining a film-like glass having a thickness of 0.1 to 2 mm. The obtained film-like glass was ground in a ball mill and a planetary ball mill to obtain each of glass powders (positive electrode active material precursor powders) having respective particle diameters shown in Table 1. Furthermore, the glass powders were measured in terms of crystallization temperature with a DTA (DTA 8410 manufactured by Rigaku Corporation). As a result of powder X-ray diffraction (XRD) measurement, all of the obtained glass powders were confirmed to be amorphous.

(b) Making of Solid Electrolyte Layer and Solid Electrolyte Powder

(b-1) Making of β″-Alumina Solid Electrolyte Layer and β″-Alumina Solid Electrolyte Powder

Li₂O-stabilized β″-alumina (manufactured by Ionotec Ltd., composition formula: Na_{1.7}Li_{0.3}Al_{10.7}O₁₇) was processed into a 0.5-mm thick sheet, thus obtaining a solid electrolyte layer. Furthermore, the Li₂O-stabilized β″-alumina in sheet form was ground in a ball mill and a planetary ball mill to obtain each of solid electrolyte powders having respective particle diameters shown in Table 1.

(b-2) Making of NASICON Solid Electrolyte Layer and NASICON Solid Electrolyte Powder

Using sodium carbonate (Na₂CO₃), yttria-stabilized zirconia having an yttrium content of 3.0% ((ZrO₂)_{0.97}(Y₂O₃)_{0.03}), silicon dioxide (SiO₂), and sodium metaphosphate (NaPO₃), these powdered raw materials were formulated to give a composition of, in terms of % by mole, 25.3% Na₂O, 31.6% ZrO₂, 1.0% Y₂O₃, 33.7% SiO₂, and 8.4% P₂O₅. Next, the powdered raw materials were wet mixed for four hours using ethanol as a medium. Then, ethanol was evaporated, the powdered raw materials were pre-fired at 1100° C. for eight hours and then ground, and the ground powder was classified with an air classifier (type MDS-3 manufactured by Nippon Pneumatic Mfg. Co., Ltd.). Using an acrylic acid ester-based copolymer (OLYCOX KC-7000 manufactured by Kyoeisha Chemical Co., Ltd.) as a binder and benzyl butyl phthalate as a plasticizer, these materials and the classified powder were weighed to reach a ratio of raw material powder to binder to plasticizer of 83.5:15:1.5 (mass ratio) and the mixture was dispersed into N-methylpyrrolidinone, followed by well stirring with a planetary centrifugal mixer to form a slurry.

The slurry obtained as above was applied onto a PET film and dried at 70° C., thus obtaining a green sheet. The obtained green sheet was pressed at 90° C. and 40 MPa for five minutes using an isostatic pressing apparatus. The pressed green sheet was fired at 1220° C. for 40 hours in an atmosphere of a dew point of −40° C. or lower, thus obtaining a solid electrolyte layer containing NASICON crystals.

Furthermore, the powder obtained after the above classification was uniaxially pressed into a shape at 40 MPa in a 20-mm diameter die and then fired at 1220° C. for 40 hours in an atmosphere of a dew point of −40° C. or lower to obtain a solid electrolyte containing NASICON crystals. The obtained solid electrolyte was ground, thus obtaining a solid electrolyte powder having a particle diameter shown in Table 1.

(c) Production of Test Cell

The positive electrode active material precursor powder and solid electrolyte powder obtained as above, and acetylene black (SUPER C65 manufactured by TIMCAL) as a conductive carbon were weighed at each ratio described in Table 1 and these powders were mixed for 30 minutes with an agate pestle in an agate mortar. An amount of 10 parts by mass of polypropylene carbonate was added to 100 parts by mass of the mixed powder and 30 parts by mass of N-methylpyrrolidinone was further added to the mixture, followed by well stirring with a planetary centrifugal mixer to form a slurry.

The obtained slurry was applied, with an area of 1 cm² and a thickness of 80 μm, to one of the surfaces of the solid electrolyte layer obtained as above and then dried at 70° C. for three hours. Next, the product was put into a carbon container and thermally treated under conditions described in Table 1 to form a positive electrode material layer on the one surface of the solid electrolyte layer. All the above operations were performed in an environment of a dew point of −40° C. or lower.

When the powder X-ray diffraction patterns of the obtained positive electrode material layers were checked, Na₂FeP₂O₇ crystals were confirmed in Examples 1 to 9 and maricite NaFePO₄ crystals were confirmed in the comparative example. Furthermore, in each of the positive electrode material layers, diffraction lines originating from the solid electrolyte powder used were confirmed.

In observing the cross section of each of the positive electrode material layers with FESEM-EDX, the number and area rate of solid electrolyte powder particles having a particle diameter of 0.5 μm or less in a 1 μm×1 μm view area were calculated. These values were determined based on a mapping of elements contained in the solid electrolyte powder. The results are shown in Table 1.

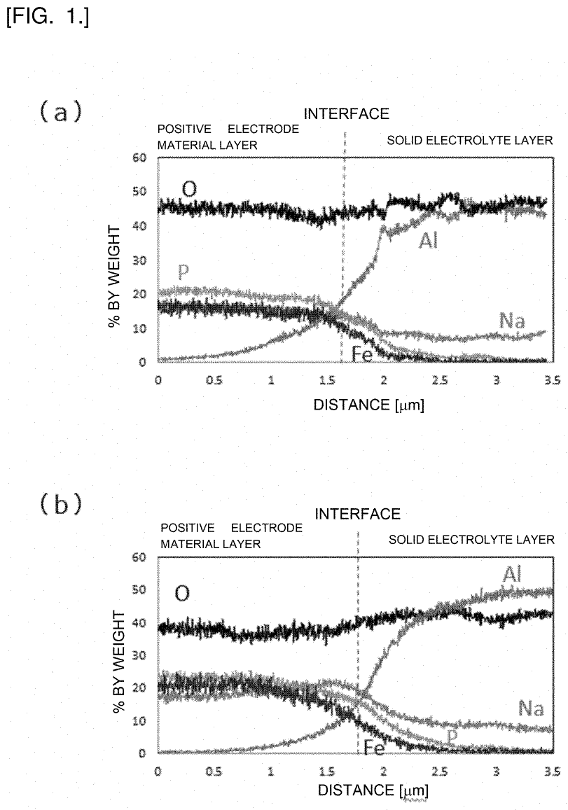

The cross section of the positive electrode material layer and the solid electrolyte layer was observed with FESEM-EDX and elements contained in the interface between both the layers were mapped. Elemental mapping profiles of Example 1 and the comparative example are shown in FIGS. 1(a) and 1 (b), respectively. By comparison between the profiles of FIGS. 1(a) and 1 (b), it can be confirmed that in the profile of 1 (b) some of Na elements diffused from the positive electrode material layer into the solid electrolyte layer. This can be considered to be derived from a heterogeneous phase (maricite NaFePO₄ crystal phase or so on) formed at the interface between both the layers. The thicknesses of respective heterogeneous phases of the products were determined from their elemental mapping profiles. The results are shown in Table 1.

Next, a current collector of a 300-nm thick gold electrode was formed on the surface of each of the positive electrode material layers using a sputtering device (SC-701AT manufactured by Sanyu Electron Co., Ltd.). Thereafter, in an argon atmosphere of a dew point of −60° C. or lower, metallic sodium serving as a counter electrode was pressure-bonded to the other surface of the solid electrolyte layer and the obtained product was placed on a lower lid of a coin cell and covered with an upper lid to produce a CR2032-type test cell.

(d) Charge and Discharge Test

The produced test cells underwent a charge and discharge test at 30° C. to measure their discharge capacities. The results are shown in Table 1. The discharge capacity is defined as an amount of electricity discharged per unit mass of the positive electrode active material powder contained in the positive electrode material layer. In the charge and discharge test, charging was implemented by CC (constant-current) charging from the open circuit voltage (OCV) to 4.5 V and discharging was implemented by CC discharging from 4.5 V to 2 V. The test was conducted under each of conditions of C-rates of 0.02 C, 0.1 C, 0.2 C, and 1 C.

(e) Internal Resistance Evaluation Test

Changes in internal resistance of the produced test cells when charged and discharged at 30° C. were determined by 3D impedance measurement using VMP-300 from Bio-Logic Science Instruments and pieces of software Z-3D, Z-ASSIST, and Z-FIT-Analysis produced by TOYO Corporation. The 3D impedance measurement was performed in the following manner. In charging the test cell at 0.01 C from the open circuit voltage (OCV) to 4.5V in the Galvano Electrochemical Impedance Spectroscopy mode, impedance measurement was made while an electric current was applied to the test cell with frequencies from 7 MHz to 10 mHz to give a response voltage of 5 mV. Subsequently, impedance measurement was made likewise while the test cell was discharged at 0.01 C from 4.5 V to 2 V. From a Nyquist plot obtained by the impedance measurement, changes in resistant value of each of resistance components forming the cell in the charge and discharge processes were determined using the above pieces of software. Among the resistance components, the lowest one of resistance values per unit area of each positive electrode material layer in the discharge process is shown as an internal resistance in Table 1.

As is obvious from Table 1, Examples 1 to 9 exhibited excellent discharge capacities of 79 to 96 mAh/g at 0.02 C, 58 to 92 mAh/g at 0.1 C, and 42 to 87 mAh/g at 0.2 C. Furthermore, Examples 1 to 3, 5, 6, 8, and 9 could be charged and discharged even when the rate was increased to 1 C, in which case they exhibited discharge capacities of 39 to 75 mAh/g. Unlike the above, the comparative example exhibited low discharge capacities of 68 mAh/g at 0.02 C and 35 mAh/g at 0.1 C and could not be charged and discharged at 0.2 C and 1 C.

1. A method for manufacturing a positive electrode material for an electricity storage device, the method comprising the step of subjecting a raw material containing a positive electrode active material precursor powder made of an amorphous oxide material to thermal treatment, wherein the positive electrode active material precursor powder has a crystallization temperature of 490° C. or lower.

2. The method for manufacturing a positive electrode material for an electricity storage device according to claim 1, wherein a temperature during the thermal treatment is 400 to 600° C.

3. The method for manufacturing a positive electrode material for an electricity storage device according to claim 1, wherein a time for the thermal treatment is less than three hours.

4. The method for manufacturing a positive electrode material for an electricity storage device according to claim 1, wherein the thermal treatment is performed in a reductive atmosphere.

5. The method for manufacturing a positive electrode material for an electricity storage device according to claim 1, wherein the positive electrode active material precursor powder has an average particle diameter of 0.01 to less than 0.7 μm.

6. The method for manufacturing a positive electrode material for an electricity storage device according to claim 1, wherein the positive electrode active material precursor powder contains, in terms of % by mole of the following oxides, 25 to 55% Na₂O, 10 to 30% Fe₂O₃+Cr₂O₃+MnO+CoO+NiO, and 25 to 55% P₂O₅.

7. The method for manufacturing a positive electrode material for an electricity storage device according to claim 1, wherein the raw material contains a solid electrolyte powder.

8. The method for manufacturing a positive electrode material for an electricity storage device according to claim 7, wherein the solid electrolyte powder is β-alumina, β″-alumina or NASICON crystals.

9. The method for manufacturing a positive electrode material for an electricity storage device according to claim 7, wherein the solid electrolyte powder has an average particle diameter of 0.05 to 3 μm.

10. The method for manufacturing a positive electrode material for an electricity storage device according to claim 1, wherein the raw material contains a conductive carbon.

11. The method for manufacturing a positive electrode material for an electricity storage device according to claim 1, wherein the raw material contains, in terms of % by mass, 30 to 100% positive electrode active material precursor powder, 0 to 70% solid electrolyte powder, and 0 to 20% conductive carbon.

12. A positive electrode active material precursor powder for an electricity storage device, the positive electrode active material precursor powder being made of an amorphous oxide material having a crystallization temperature of 490° C. or lower.

13. The positive electrode active material precursor powder for an electricity storage device according to claim 12, the positive electrode active material precursor powder having an average particle diameter of 0.01 to less than 0.7 μm.

14. The positive electrode active material precursor powder for an electricity storage device according to claim 12, the positive electrode active material precursor powder containing, in terms of % by mole, 25 to 55% Na₂O, 10 to 30% Fe₂O₃+Cr₂O₃+MnO+CoO+NiO, and 25 to 55% P₂O₅.

15. A positive electrode material for an electricity storage device, the positive electrode material containing a solid electrolyte and a positive electrode active material and having a matrix-domain structure formed of the positive electrode active material as a matrix component and the solid electrolyte as a domain component.

16. The positive electrode material for an electricity storage device according to claim 15, wherein a number of solid electrolyte powder particles having a diameter of 0.5 μm or less is two or more in a 1 μm×1 μm cross-sectional view area.

17. An electricity storage device comprising a positive electrode material layer made of the positive electrode material for an electricity storage device according to claim 15.

18. The electricity storage device according to claim 17, comprising a solid electrolyte layer, wherein the positive electrode material layer is formed on a surface of the solid electrolyte layer.

19. The electricity storage device according to claim 18, wherein a heterogeneous phase at an interface between the positive electrode material layer and the solid electrolyte layer has a thickness of 1 μm or less.

20. The electricity storage device according to claim 17, wherein an internal resistance per unit area of the positive electrode material layer at 30° C. is 2000 Ωcm² or less as a minimum value in a discharge process.
